(19) United States
(12) Patent Application Publication
(10) Pub. No.: US 2004/0091380 A1
(43) Pub. Date: May 13, 2004

(54) Two-shaft vacuum pump

(76) Inventors: Hartmut Kriehn, Koln (DE); Lothar Brenner, Munstereifel (DE); Manfred Behling, Koln (DE); Thomas Dreifert, Kerpen (DE); Klaus Rofall, Rosrath (DE); Heinrich Englander, Linnich (DE); Michael Froitzheim, Dormagen (DE)

Correspondence Address: Thomas E Kocovsky Jr, Fay Sharpe Fagan Minnich & McKee, Seventh Floor, 1100 Superior Avenue, Cleveland, OH, 44114-2518, US

(21) Appl. No.: 10/343,958

(22) PCT Filed: Jul. 6, 2001
(86) PCT No.: PCT/EP01/07739

(30) Foreign Application Priority Data
Aug. 10, 2000 (DE) 100-39-006.4

(51) Int. Cl. F03C 2/00

(52) U.S. Cl. 418/179; 418/201.1

(57) ABSTRACT

A vacuum pump has two shafts (3, 4) and two rotors (1, 2) which co-operate with each other and which are fixed to the shafts. The rotors are cantilevered on the shafts. The rotors are fixed to the shafts in a manner which is devoid of backlash, even during temperature changes. In order to achieve this, the shafts (3, 4) are made of a material having a modulus of elasticity which is as high as possible, e.g., steel. The rotors (1, 2) are made of a material having a density which is as low as possible, e.g., aluminum or a titanium alloy. Structures (8; 11, 12, 13; 14, 15; 25, 27; 38, 41; 43, 44, 45; etc.) are provided to ensure that the rotors (1, 2) are fixed to the shafts (3, 4) in a manner which is devoid of backlash at all operating temperatures.

The present invention relates to a vacuum pump comprising two shafts and two rotors which co-operate with each other and which are fixed to the shafts whereby the rotors are cantilevered by means of the shafts.

The developers and manufacturers of pumps of the mentioned kind, screw pumps in particular, are following up the aim of being able to operate such pumps at reasonable manufacturing costs at as high as possible speeds, and with leaks through slots as small as possible, in order to attain the purpose—vacuum generation—as effectively as possible. The pre-requisites for this are precise bearings and fitting of the rotors to the shafts devoid of backlash—also in the warm state. As to the bearing it needs to be considered that the rotors shall be cantilevered. This is commonly performed through two each bearings between which there is located a drive motor. In particular, in the instance of screw vacuum pumps such a kind of bearing has been found to be expedient, since its benefits—no seal on the intake side, more cost-effective compared two double-flow solutions—are greater than the disadvantages—higher requirements as to shaft and bearing.

The cantilevered arrangement is the cause for problems relating to affixing of the rotors to their shafts devoid of backlash. It is known that in the instance of a cantilevered arrangement it is expedient that the center of gravity of the rotating system be located in the vicinity of the bearing on the rotor side. This can be achieved in that a material being as light in weight as possible, aluminium for example, is selected for the rotor. However, aluminium has a significantly greater coefficient of thermal expansion (about 23×10⁻⁶/K) compared to steel (12×10⁻⁶/K) which in the case of cantilevered arrangements is specially well suited as the material for the shaft. Steel has a high modulus of elasticity thus enabling the manufacture of stiff shafts. In the instance of the material pair steel/aluminium it is difficult to affix the rotor to the shaft devoid of backlash at all operating temperatures (between ambient temperature and approximately 200° C.). There exists, in fact, the possibility of employing as to the expansion problem more favourable materials like steel, Ti or ceramics for the rotor. However, these result in rotors being too heavy (St) or too expensive (Ti, ceramics). Also aluminium is not a possibility for the shaft material owing to its low modulus of elasticity.

From DE-199 63 171 A1 a vacuum pump having the aforementioned characteristics is known. Affixing of the rotor to the shaft devoid of backlash also in the warm state is not covered.

It is the task of the present invention to create a vacuum pump having the aforementioned characteristics which will optimally fulfil the aims of the manufacturers and developers of such vacuum pumps.

This task is solved through the characterising measures of the patent clams.

In that the shafts are made of a material having a modulus of elasticity which is as high as possible (steel, for example), precise guidance of the shafts and thus the rotors is ensured so that the slots between the rotors themselves and the housing walls can be kept small. Also the means which ensure affixing of the rotors to the shafts devoid of backlash have this effect. Lighter rotor materials compared to the material for the shaft will allow the pump to be operated at high rotational speeds.

The means of ensuring fixing of the rotors to their shafts devoid of backlash at all operating temperatures may be implemented differently. In the instance of greater differences between the coefficients of expansion of the materials involved, the rotors and the shafts may be designed in such a manner that the freedom from backlash is ensured through warm centering, cold centering and/or friction centering. Also bindings preventing a greater expansion of the aluminium rotor on the steel shaft are possible. Finally—supported or alone—a cooling arrangement may be present which restricts or prevents temperature fluctuations at the joints.

As already mentioned, it would be simple to employ materials having approximately the same coefficient of expansion. To this end the inventors have proposed to employ aluminium alloys manufactured based on powder metallurgy, the principal components of which are Cu and Si in the alloy. Steel and aluminium alloys of this kind have approximately the same coefficient of expansion (density of the material—mass) so that through shrink joints of the type commonly employed, fixing of the rotors to the shafts devoid of backlash at all operating temperatures is ensured.

In order to succeed in placing the center of gravity of the systems each consisting of a rotor and a shaft, as close as possible to the bearing on the rotor side for the purpose of attaining high speeds several measures can be expedient:

Hollow bore in the rotor, into which the steel shaft engages only partly; if required for the purpose of guiding a coolant fluid, components having a low density (plastics, for example) can be accommodated in the bore.

Short rotors; this is achieved in screw pumps in a basically known manner through a suitable change in pitch and/or through deeply cut-in rotor profiles.

Accommodation of the shaft bearing on the rotor side in a recess on the bearing side within the rotor.

O-arrangement of the two shaft bearings and/or movable bearings at the rotor side, and fixed bearings at the side of the shaft facing away from the rotor.

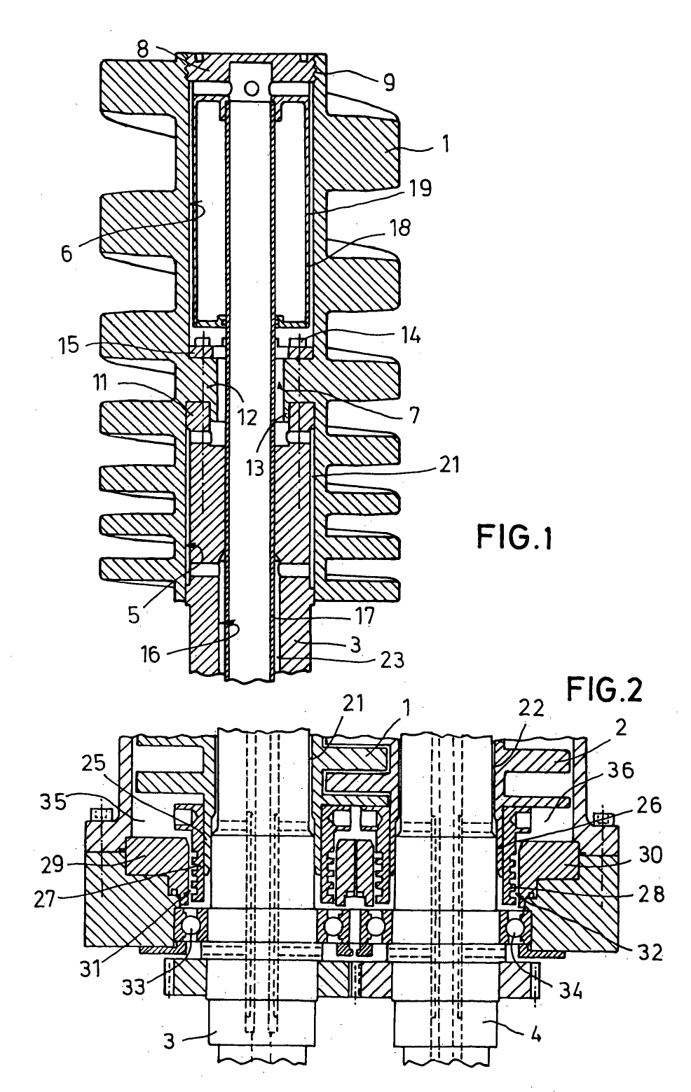

Further advantages and details shall be explained with reference to the examples of embodiments depicted schematically in drawing FIGS. 1 to 5. Depicted are:

In the drawing figures the rotors are designated as 1 (resp. 1 and 2 in drawing FIG. 2) and their shafts as 3 (resp. 3, 4). The rotors are cantilevered and equipped with axial hollow bores into which the bare ends of the shafts 3, 4 extend. The rotors 1, 2 are each fixed on to the shaft ends devoid of backlash.

In the example of an embodiment in accordance with drawing FIG. 1 the rotor 1 has on its face sides two hollow bores 5 and 6 which are linked to each other approximately at the center of the rotor 1 via a more narrow bore 7. In the assembled state, the opening of the hollow bore 6 on the intake side is firmly sealed with a disk 8, which is—as depicted—screwed into the hollow bore with the aid of a thread 9, for example.

In the hollow bore 5 on the bearing side there already ends the shaft 3¹⁾ which is equipped on its face side with an axially oriented collar 11. In the area of the more narrow bore 7 linking the hollow bores 5 and 6, the annular protrusion 12 extending to the inside is equipped with an axially oriented collar 13, the direction and diameter of which are so selected that it rests from the inside against the collar 11 of the shaft 3²⁾. If the shaft 3 is made of steel and the rotor 1 of aluminium having, compared to steel, a greater coefficient of expansion and if the collars 11, 13 rest against each other at ambient temperature devoid of backlash, there results an inner centering which remains devoid of backlash also at higher temperatures. ¹⁾ Translator's note: The German text states “1” here whereas “3” would be more in line with the remaining text and the drawing figures. Therefore the latter has been assumed for the translation. ²⁾ Translator's note: The German text states “1” here whereas “3” would be more in line with the remaining text and the drawing figures. Therefore the latter has been assumed for the translation.

For the purpose of joining rotor 1 and shaft 3 there are provided axial bolts 14 which are accessible from the hollow bore 6. These penetrate the protrusion 12 of the rotor 1 and are screwed into the collar 11 of the shaft. Expediently, a ring 15 made of the same material as the shaft is assigned to the heads of the bolts. Thus there results besides warm centering also friction centering.

Moreover, shaft 3 and rotor 1 are equipped with a system of cooling channels for the purpose of reducing temperature related problems. To this end the shaft 3 is equipped with a central bore 16. Located in this bore 16 is a pipe section 17 which extends into the hollow bore 6 and which serves the purpose of feeding in a coolant. Within the hollow bore 6, hollow (thin walled) and/or light installations 18 affixed to pipe section 17 form an outer annular channel 19, which among other things, is linked via the bore 7 to an outer annular channel 21 in the hollow bore 5 formed by the shaft 3 and the inner wall of the hollow bore 5. Via these annular channels 19, 21 and thereafter via the annular channel 23 in the shaft being provided by pipe section 17 and the inner wall of the bore 16, the coolant flows back. A reverse direction for the coolant flow may also make sense.

In drawing FIG. 2 the rotors 1, 2 are equipped on the bearing side with collars 25, 26, said collars encompassing the shafts 3, 4 from the outside. If the rotor material has a greater coefficient of expansion than the shafts, backlashes may be present between rotors and shaft when the temperatures increase in the instance of outer centering of this kind. In order to avoid this, rings 27, 28 are provided which in turn encompass the collars 25, 26. If the coefficient of expansion of the materials for the rings 27, 28 is equal or even smaller than the coefficient of expansion of the material for the shaft, rings 27, 28 will at increasing temperatures prevent an expansion of the collars 25, 26 and thus the undesirable backlashes.

A cooling system in accordance with the cooling system of drawing FIG. 1 is provided. The annular channels 21, 22 extend up into the areas of the collars 25, 26. Said annular channels reduce the maximum operating temperatures which may occur and thus equally remove the risk of backlashes.

From the outside the rings 27, 28 are equipped with annular grooves in which piston rings which are not depicted, are located. These form jointly with the rings 29, 30 affixed to the housing, labyrinth seals 31, 32 which serve the purpose of preventing the ingress of lubricant vapours from the bearings 33, 34 into the pump chambers 35, 36 of the screw pump.

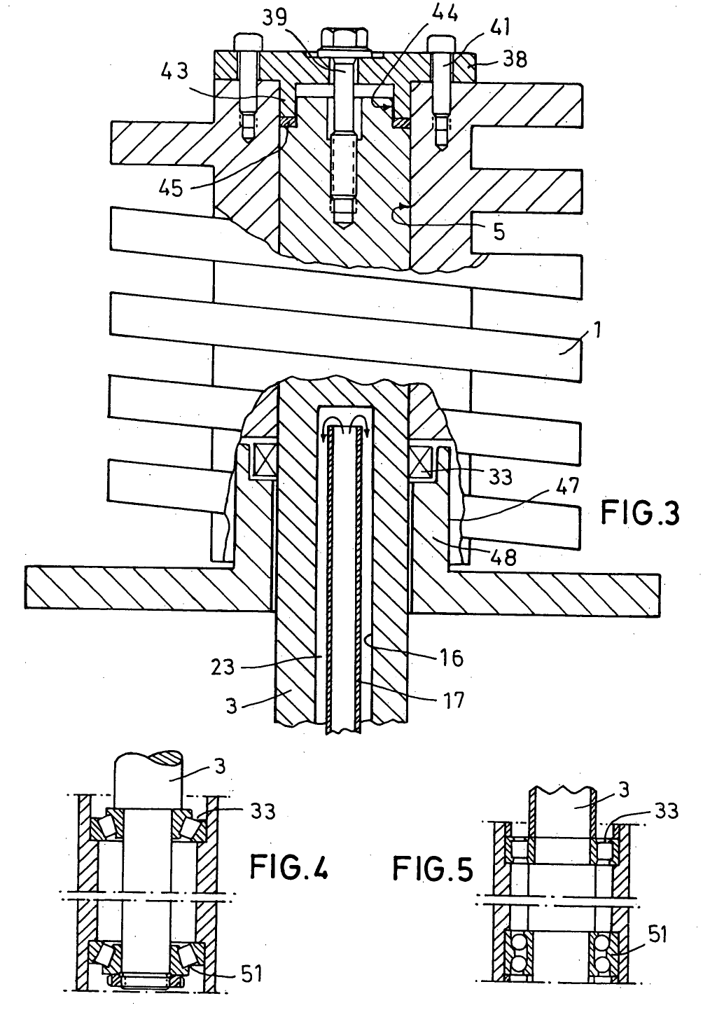

In the example of an embodiment in accordance with drawing FIG. 3, frictional centering has been implemented. To this end a disk 38 is provided which initially has the task of sealing off the opening of the hollow bore 5 on the intake side. The disk 38 is firmly joined to both the shaft 3 (bolt 39) and also the rotor (several bolts 41). If the rotor material has a greater coefficient of expansion compared to shaft 3 and if the disk 38 consists, for example, of the shaft material, then the fixed bolted joint will prevent the formation of backlash at increasing temperatures.

As depicted in drawing FIG. 3 the disk 38 may be equipped with an axially oriented collar 43 which engages into the hollow bore 5. Thus at the same time warm centering can be attained. To this end, it is required that rotor 1, shaft 3 and disk 38 be fitted without backlash in the warm state. Due to the already mentioned conditions with respect to the coefficients of expansion, this type of mounting is devoid of backlash at decreasing temperatures. This also applies to fixing of the rotor/shaft without disk 38.

Fixing of the rotor to the shaft may also be effected by means of a press fit joint. If the rotor consists of aluminium and the shaft of steel, then it is in this instance expedient that the ambient temperature at which this press fit joint is manufactured, corresponds approximately to the maximum temperature encountered by the rotors (1, 2) which occurs during operation of the two-shaft vacuum pump.

A joint of this kind is devoid of backlash at all occurring operating temperatures of the two-shaft vacuum pump.

Also depicted in drawing FIG. 3 is that the collar 43 and the face side of the shaft 3 rest against each other, preferably within an outer recess 44 in the shaft 3. Located between the facing supporting surfaces of collar 43 and shaft 3 is an adjusting ring 45. By inserting adjusting rings 45 differing in thickness—or through collars 43 differing in height—the axial position of the rotor 1 with respect to shaft 3 can be defined. Thus there exists the possibility of adjusting flank-to-flank backlash of the rotor 1 with respect to the second rotor not depicted. Disk 38 may simultaneously serve the purpose of balancing and/or torque transfer (by way of a tooth lock washer, for example).

Finally depicted in drawing FIG. 3 is the possibility of arranging the bearing 33 on the rotor side in a recess 47 at the bearing side in rotor 3. An axially extending bearing support 48 engages into the recess 47. The system of cooling channels (bore 16 in the shaft 3, pipe section 17) extends up to bearing 33 so as to maintain the bearing temperatures at a low level.

In order to reliably attain the desired high speeds it is expedient that the two shaft bearings 33, 51 have an O type arrangement as depicted in drawing FIG. 4. In bearings of this kind the point of application of the force is shifted by the pressure angle in the direction of the rotor's center of gravity. In view of this, also a movable bearing 33 at the rotor side and a fixed bearing 51 at the side of shaft 3 facing away from the rotor is expedient. Drawing FIG. 5 depicts this arrangement. The point of application of the force is at the bearing center.

1. Vacuum pump comprising two shafts (3, 4) and two rotors (1, 2) which co-operate with each other and which are fixed to the shafts and where the rotors are cantilevered by means of the shafts, wherein the shafts (3, 4) consist of a material having a modulus of elasticity which is as high as possible, e.g. steel, the rotors (1, 2) consist of a material having a density which is as low as possible, e.g. aluminium or a titanium alloy, and means are provided to ensure that the rotors (1, 2) are fixed to the shafts (3, 4) in a manner which is devoid of backlash at all operating temperatures.

2. Pump according to claim 1, wherein means for cold centering, warm centering and/or friction centering of the rotor (1, 2) on its shaft (3, 4) are provided.

3. Pump according to claim 2, wherein the means for the purpose of warm centering consist of axially extending collar sections (12, 13) at the rotor (1, 2), resp. at the shaft (3, 4) and where the collar section (13) of the rotor (1, 2) is located inside.

4. Pump according to claim 2, wherein the means for friction centering consist of axially oriented bolts (14, 39, 41) with which the rotor (1, 2) and the shaft (3, 4) are joined to each other.

5. Pump according to claim 1, wherein the rotor (1, 2) has a hollow bore and where on the intake side of the rotor a disk (38) is arranged.

6. Pump according to claim 5, wherein the disk (38) is equipped with a collar (43) engaging into the hollow bore (5) of the rotor (1, 2), said disk effecting cold centering.

7. Pump according to claim 6, wherein the collar (43) and the shaft (3) rest against each other, specifically through an adjusting ring (45).

8. Pump according to claim 1, wherein the rotor (1, 2) is equipped with a collar (25, 26) which encompasses the shaft (3, 4) and where a binding (27, 28) is provided which in turn encompasses the collar (25, 26).

9. Pump according to one of the above claims, wherein there is located at the level of the joints between shaft (3, 4) and rotor (1, 2) a cooling facility.

10. Pump according to claim 1, wherein the coefficients of expansion of the materials for the rotor (1, 2) and the shaft (3, 4) are approximately equal.

11. Pump according to claim 10, wherein the shaft (3, 4) is made of steel and the rotor (1, 2) of aluminium alloy manufactured based on powder metallurgy, the principal components of which are Cu and Si in the alloy.

12. Pump according to one of the above claims, wherein the rotor (1, 2) has a hollow space and where the shaft (3, 4) only partly penetrates the hollow space.

13. Pump according to claim 12 wherein there are located in the hollow space not occupied by the shaft (3, 4) light-weight components (18) which guide a coolant flow.

14. Pump according to one of the above claims, wherein the rotors (1, 2) are as short as possible in the axial direction and where the pitch of the thread decreases from the intake to the discharge side.

15. Pump according to one of the above claims, wherein the bearing (33) on the rotor side is located in a recess (47) in the rotor (1, 2).

16. Pump according to one of the above claims, wherein the two bearings (33, 51) of the shaft (3, 4) have an O type arrangement.

17. Pump according to one of the claims 1 to 15, wherein the bearing (33) adjacent with respect to the rotor (1, 2) is a movable bearing and the bearing (51) remote from the rotor (1, 2) is a fixed bearing.

18. Method for manufacturing a unit consisting of a hollow drilled aluminium rotor (1, 2) and a hollow bore (5) in the rotor with a shaft (3, 4) made of steel for a two-shaft vacuum pump, said shaft penetrating said hollow bore at last in part, wherein between the rotor (1, 2) and the shaft (3, 4) there is provided a press fit joint and where the ambient temperature at which said press fit joint is provided corresponds approximately to the maximum temperature of the rotors (1, 2) which is attained during operation of the two-shaft vacuum pump.
